(19) United States
(12) Patent Application Publication
(10) Pub. No.: US 2026/0140015 A1
(43) Pub. Date: May 21, 2026

(54) Test Bench for Geared System

(71) Applicants: PETRÓLEO BRASILEIRO S.A. - PETROBRAS, Rio de Janeiro (BR); UNIVERSIDADE ESTADUAL DE CAMPINAS - UNICAMP, Campinas (BR)

(72) Inventors: Ronaldo Lucas Alkmin Freire, São José dos Campos (BR); Áquila Chagas de Carvalho, Campinas (BR); Franco Giuseppe Dedini, Campinas (BR); Jony Javorski Eckert, Campinas (BR); Helio Fiori de Castro, Campinas (BR); Fabio Mazzariol Santiciolli, Campinas (BR); Lucas Nogueira Garpelli, Campinas (BR); Leonardo Ishimoto, Santos (BR)

(73) Assignees: PETRÓLEO BRASILEIRO S.A. - PETROBRAS, Rio de Janeiro (BR); UNIVERSIDADE ESTADUAL DE CAMPINAS - UNICAMP, Campinas (BR)

(21) Appl. No.: 19/389,610

(22) Filed: Nov. 14, 2025

(30) Foreign Application Priority Data
Nov. 21, 2024 (BR) 1020240241355

(51) Int. Cl. G01M 13/025; G01K 7/02

(52) U.S. Cl. CPC G01M 13/025; G01K 7/02

(57) ABSTRACT

The present invention relates to a test bench for geared systems with a closed power loop, which enables the collection of data on the kinematic and dynamic behavior of these systems, which can be applied to mathematical models for calibration and subsequent experimental validation. Specifically, the test bench for geared systems comprises a primary gear pair, a secondary gear pair, a gantry, a belt and pulley assembly, a drive system, a belt and pulley assembly, a torque application system, force measurement assemblies, a torque meter, and sensors.

### CROSS-REFERENCE TO RELATED APPLICATIONS

This application claims priority to Brazilian Application No. BR1020240241355 filed on Nov. 21, 2024, the disclosure of which is expressly incorporated herein by reference in its entirety.

### FIELD OF THE INVENTION

The present invention falls within the technical field of geared system testing. In particular, the present invention relates to a test bench for closed-loop power-assisted geared system for conducting tests or experiments in a controlled environment.

### BACKGROUND OF THE INVENTION

Geared systems are widely used in a variety of mechanical equipment, from industrial applications to vehicle transmission systems. However, despite their relevance, the design of these systems still faces challenges that require continuous improvement, especially in terms of efficiency, precision, and wear resistance.

To better understand the kinematic and dynamic behavior of the components that make up these systems, it is crucial to develop mathematical models that allow simulating the real operating conditions of power transmission systems. Such simulations enable the optimization of gear pairs, improving meshing accuracy, system efficiency, and mitigating the negative effects of vibrations.

The development of mathematical simulation models for power transmission systems has gained relevance over the years. These models can represent the complex kinematics and dynamics of geared systems, allowing the calculation of the forces and vibration frequencies involved, as well as the determination of the line of action of the gearing, which is a fundamental aspect for calculating the speeds transmitted by the geared pair.

In addition to enabling detailed calculation of forces and vibration frequencies, these models are important tools for identifying wear faults in gears (both on the contact surface and in cracks in the teeth) and in associated components, such as shafts, keys, and bearings.

However, mathematical models, no matter how sophisticated, depend on a series of parameters that are often not available in the existing technical literature. Furthermore, a mathematical model requires experimental validation to ensure its reliability.

For example, to accurately identify the contact line of a geared pair, an instrumented system with appropriate sensors is required, since this contact line is modified by tooth deformation, which in turn changes according to the applied load and tooth wear (a factor that alters the contact geometry).

One of the main challenges is evaluating the kinematic and dynamic effects caused by the actuation of a pair of gears with known geometry under controlled torque and speed conditions.

Therefore, the need to evaluate the kinematic and dynamic effects caused by the actuation of a pair of gears with known geometry under controlled torque and speed conditions is evident.

Furthermore, it is necessary to understand the behavior of the gears to identify and analyze potential failures, such as tooth wear and cracks.

### STATE OF THE ART

In the state of the art, there are documents focused on the development of test benches for gear systems. In particular, the documents listed below are highlighted.

The Master's thesis entitled “Design, manufacture, construction, and testing of a reduced FZG tribometer with variable loading” (https://repositorio.ufrn.br/handle/123456789/32968) discloses a tribometer capable of reproducing the contact between spur cylindrical gears, aiming to promote wear in the tested gear pairs. The tribometer is standardized by DIN ISO 14635-1:2000, ASTM D 5182-97, and DIN 51354-1, and consists of power transmission between two gearboxes interconnected by two parallel shafts in a back-to-back power recirculation format, comprising: a loading system with standard masses that aims to accelerate wear on the gear teeth by applying torque to the system through a brake caliper and disc; a rigid base made of structural aluminum profiles that provides rigidity and flexibility for future expansion of the tribometer; a mechanical torque limiter with torque preload to ensure gear engagement; and an electrical system controlled by a programmable frequency inverter.

The PHD thesis titled “Identification of Faults in Rotating Systems by Physics-Guided Neural Networks” (https://hdl.handle.net/20.500.12733/9243) discloses test benches including a pair of gears, one healthy and the other with a crack in the tooth, in which the main shaft, to which the pinion is connected, is driven by an electric motor coupled to a planetary reduction gear. The gears have a module of 2 mm, with the pinion having 25 teeth and the driven gear having 40 teeth. The cracks in the pinions were generated by wire EDM, with sizes ranging from 0.05 mm to 1.98 mm. Experimental data are collected using four accelerometers, two installed in each bearing, and two encoders responsible for monitoring the rotation so that the captured signals are processed and stored in a data acquisition system connected to a computer.

The Master's thesis titled “Modeling of a Gear Test Rig” (https://www.diva-Portal.org/smash/get/diva2:1342918/FULLTEXT02.pdf) discloses the development and validation of a simulation model for a gear test rig, addressing the importance of transmissions in the automotive industry among the transition to sustainable transportation solutions and demands for efficiency, noise, and durability. This includes static and dynamic analyses of standard gears (types A and C) in a FZG test rig, with simulations of torque fluctuations and vibrations validated by experimental measurements. The results indicate that the model can reproduce torque fluctuations and vibrations, especially with type C gears, which exhibit better performance compared to type A gears, which present numerical problems.

Despite the teachings from the state of the art, it is noted that there are no teachings focused on measuring stresses and measuring torque applied to both axes of the circuit.

Furthermore, it is noted that said documents from the state of the art are directed to the type of experiments aimed at studying wear and fatigue in closed-loop geared systems, instead of addressing the measurement of parameters related to the kinematics and dynamics of the gearing to evaluate the forces, torques, and frequencies in geared pairs as a function of the load and rotation transmitted by the closed-loop assembly.

Therefore, the features and advantages of the present invention compared to the state of the art will clearly emerge from the detailed description below and with reference to the accompanying drawings, which are provided as a preferred, non-limiting embodiment.

### SUMMARY OF THE INVENTION

The present invention, according to a preferred embodiment thereof, relates to a test bench for geared systems, comprising:
at least one primary gear pair;
at least one secondary gear pair;
at least one gantry;
at least one belt and pulley assembly;
wherein the primary gear pair is mounted on the gantry;
wherein the secondary gear pair is connected to the belt and pulley assembly; and
wherein the secondary gear pair is positioned on the opposite side of the primary gear pair;
at least one base;
wherein the base includes at least one alignment recess (30);
at least one drive system;
wherein the secondary gear pair is connected to the drive system through the belt and pulley assembly;
at least one torque application system;
plurality of force measurement assemblies;
at least one torque wrench mounted on each gear of the primary gear pair;
a plurality of sensors mounted on the gantry.

Furthermore, according to another preferred embodiment, the drive system is at least one electric drive motor.

Additionally, according to another preferred embodiment, the test bench for geared systems additionally comprises:
a plurality of bearings;
a first double-bearing bearing pair supporting the at least one torque application system;
at least a second double-bearing bearing pair supporting at least one flexible coupling;
wherein the at least one flexible coupling is mounted on the shaft opposite the torque application system;
at least a second single-bearing bearing pair;
wherein the at least one secondary gear pair is supported by the at least one second single-bearing bearing pair;
at least one bearing pair of the primary gear pair fixed to the gantry;
wherein the at least one primary gear pair is arranged on the at least one bearing pair of the primary gear pair.

Furthermore, according to another preferred embodiment, each of the plurality of force measurement assemblies includes at least one load cell;
wherein each of the plurality of force measurement assemblies includes an upper base and a lower base;
wherein one end of the load cell is fixed to the gantry by means of attachment means;
wherein another end of the load cell is fixed to the upper base of the force measurement assembly by means of attachment means;
wherein the upper base and the lower base are connected by a plurality of rods, by means of rod attachment means;
wherein the plurality of rods has a thickness less than their width.

Additionally, according to another preferred embodiment, the test bench for geared systems additionally comprises: at least one encoder arranged at the shaft ends of the primary geared pair; at least one blade coupling; at least one belt tensioner.

According to another preferred embodiment of the present invention, the plurality of force measurement assemblies comprise four force measurement assemblies, wherein two force measurement assemblies are attached to the upper part of the bearing housings of the primary gear pair, through the lower base of the force measurement assembly; and two force measurement assemblies are attached to the outer side of the bearing housings of the primary gear pair.

According to another preferred embodiment of the present invention, the lower base of the force measurement assembly is attached to the bearing housings of the primary gear pair.

According to another preferred embodiment of the present invention, the gantry includes at least one upper movable guide and at least one lateral movable guide, where the force measurement assemblies are attached; and wherein the at least one upper movable guide and the at least one lateral movable guide move relative to the gantry.

According to another preferred embodiment of the present invention, the at least one base includes a plurality of alignment recesses, at least one fixed plate, and at least one movable plate; wherein the at least one fixed plate and the at least one movable plate are coupled to the alignment recesses by means of fastening means; wherein the movable plate is movable on the base; wherein the at least one base also includes at least one gantry base plate; and wherein the gantry is fixed to the base by means of the gantry base plate.

According to another preferred embodiment of the present invention, the torque applicator includes at least two flanges; wherein the flanges are angularly offset by means of arms with nuts and adjustment means; and wherein the arms with nuts are articulated and secured to the flanges through means for fixing the arm to the flange.

According to another preferred embodiment of the present invention, the plurality of sensors comprises at least one of: at least one accelerometer and at least one thermocouple sensor; wherein the at least one accelerometer is mounted on the side and top of at least one bearing pair of the primary gear pair; wherein the at least one thermocouple sensor is arranged within at least a first lubricating oil box of the at least one primary gear pair; wherein the at least one first lubricating oil box includes at least one cover of the first lubricating oil box and a support base of the first lubricating oil box; wherein the support base of the first lubricating oil box is arranged between the first lubricating oil box and at least one base plate of the gantry; wherein the at least one secondary gear pair includes at least a second lubricating oil box and at least one cover of the second lubricating oil box; wherein the at least one second lubricating oil box is attached to at least one fixed plate and to at least one movable plate, using box attachment means.

### BRIEF DESCRIPTION OF THE FIGURES

In order to complement the present description and obtain a better understanding of the features of the present invention, a set of figures is shown, which, in a non-limiting manner, represent its preferred embodiment.

FIG. 1 illustrates a front perspective view of the test bench for geared systems.

FIG. 2 shows a top view of the test bench for geared systems, highlighting the closed power circuit.

FIG. 3 shows another perspective view of the test bench for geared systems.

FIG. 4 shows a front view of the test bench for geared systems.

FIG. 5 details the coupling of the load cells of the test bench for geared systems.

FIG. 6 shows the operating principle of the force measurement assembly.

FIG. 7.1 shows a cross-sectional view of the test bench for geared systems, highlighting the wheelbase variation.

FIG. 7.2 shows an enlarged detail of the test bench for geared systems.

FIG. 8.1 shows a side perspective view of the test bench for geared systems.

FIG. 8.2 shows a top view of the test bench for geared systems, highlighting the wheelbase variation.

FIG. 8.3 illustrates an additional top view of the test bench for geared systems, highlighting the wheelbase variation.

FIG. 9 shows another perspective view of the test bench for geared systems, with special detail on the torque applicator.

FIG. 10 shows another front view of the test bench for geared systems.

FIG. 11 shows an enlarged detail of the test bench for geared systems.

### DETAILED DESCRIPTION OF THE INVENTION

The present invention relates to a test bench for geared systems that allows obtaining data on the kinematic and dynamic behavior of these systems, which can be applied to mathematical models for calibration and subsequent experimental validation.

Furthermore, the test bench for geared systems allows evaluating measured parameters in the presence of known gear faults. More specifically, the test bench for geared systems allows experiments to be performed under several load and system rotation conditions, independently, obtaining data on vertical and horizontal forces, as well as the torque applied to each shaft and its respective rotation. In particular, it is also possible to obtain data on vibration frequencies using the test bench for geared systems of the present invention.

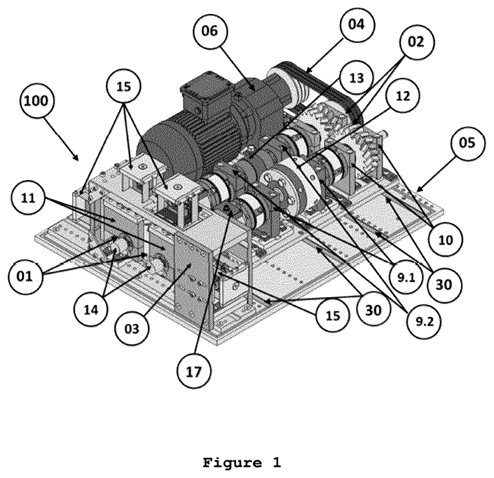

As illustrated in FIG. 1, the test bench for geared system (100), according to a preferred embodiment of the present invention, comprises:
at least one primary gear pair (01);
at least one secondary gear pair (02);
at least one gantry (03);
at least one set of belts and pulleys (04);
wherein the primary gear pair (01) is mounted on the gantry (03);
wherein the secondary gear pair (02) is connected to the set of belts and pulleys (04); and
wherein the secondary gear pair (02) is positioned on the opposite side to the primary gear pair (01);
at least one base (05);
wherein the base (05) includes at least one alignment recess (30);
at least one drive system (06);
wherein the secondary gear pair (02) is connected to the drive system (06) through the belt and pulley set (04).

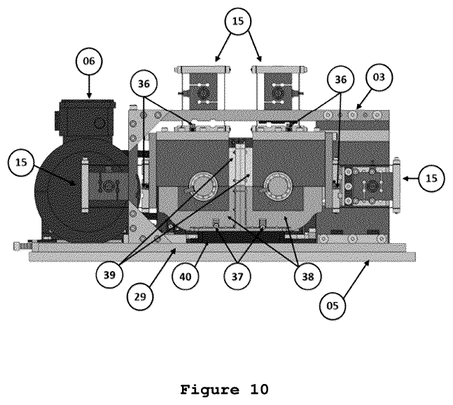

A plurality of sensors (36, 37) are mounted on the gantry (03) and serve to measure the dynamic effects during the experiments performed on the test bench for geared system (100) of the present invention, as is better detailed below, with respect to FIG. 10.

The secondary gear pair (02) is connected to a set of belts and pulleys (04), which connect the secondary gear pair (02) to the drive system (06), which is responsible for driving all elements of the test bench for geared systems (100). Specifically, the only power input to the test bench for geared systems (100) is through the set of belts and pulleys (04) that connects the electric motor (06) to the secondary gear pair (02).

In particular, the test bench for geared systems (100) includes a base (05) where all components are mounted.

In particular, the drive system (06) may be at least one electric drive motor which is responsible for driving all elements of the bench (100) of the present invention.

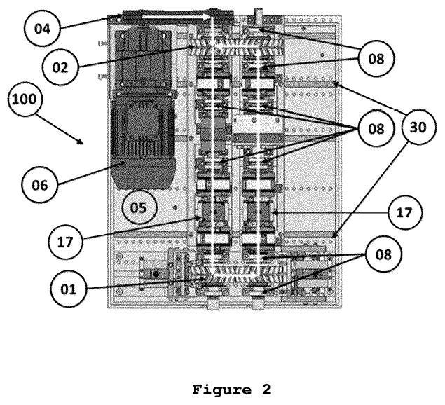

Additionally, according to FIG. 2, it is possible to observe that the test bench for geared systems (100) comprises a closed power circuit between the primary gear pair (01) and the secondary gear pair (02), with the only power input being through the belt and pulley assembly (04) that couples the drive system (06) to the secondary gear pair (02). Specifically, since there is no load coupled to the bench (100), the drive system (06) alone supplies the torque corresponding to the efficiency losses of the closed-loop components, keeping the components rotating at the specified speed.

Furthermore, as illustrated in FIG. 2, the test bench for geared systems (100) comprises a plurality of bearings (08), which are mounted in their respective bearing housings; and wherein all rotating systems are supported by the bearings (08).

The test bench for geared systems (100) further comprises at least a first pair of double-bearing bearings (9.1) that is arranged in the central part of the test bench for geared systems (100), wherein the at least one first pair of double-bearing bearings (9.1) supports at least one torque application system (12), which applies an angular offset in the closed loop, emulating a loading.

Furthermore, the test bench for geared systems (100) further comprises at least a second pair of double-bearing bearings (9.2) that supports at least one flexible coupling (13); wherein the flexible coupling (13) is mounted on the shaft opposite the torque application system (12), in order to compensate for any overload, thus avoiding plastic deformations in components.

Additionally, the primary gear pair (01) is arranged in at least one primary gear pair bearing pair (11), which is fixed to the gantry (03), as illustrated in FIG. 1.

Further, according to FIG. 1, the gantry (03) includes a plurality of force measurement assemblies (15), wherein each of the plurality of force measurement assemblies (15) includes at least one load cell (19) and a plurality of thin rods (23). Preferably, the test bench for geared systems (100) comprises at least 4 (four) force measurement assemblies (15) and at least 4 (four) load cells (19). In particular, the force measurement assembly (15) aims to decouple the forces resulting from the force engagement in the horizontal and vertical directions of the engagement, allowing measurements of the forces acting in both directions.

The coupling between the bearing pair of the primary gear pair (11) and the gantry (03) is performed by the force measurement assemblies (15).

The secondary gear pair (02) is supported on at least a second single-bearing bearing (10), which is fixed to the base (05).

The test bench for geared systems (100) additionally comprises at least one encoder (14), which is arranged at the shaft ends of the primary geared pair (01), as shown in FIG. 1.

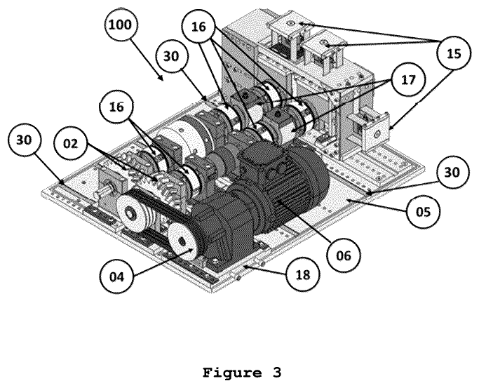

According to FIG. 3, the test bench for geared systems (100) additionally comprises at least one blade coupling (16), more preferably, at least 2 (two) blade couplings (16), which are torsionally rigid, having no clearances that could make the experiments unfeasible. All rotating components of the primary and secondary gear pairs are connected by the blade couplings (16).

Still according to FIG. 3, the test bench for geared systems (100) additionally comprises at least one torque wrench (17), more preferably, at least two torque wrenches (17). The torque wrenches (17) are mounted on both sides of the closed power circuit, in order to monitor the torque differences in both branches. More specifically, the torque wrenches (17) are mounted on the primary gear pair (01).

FIG. 3 also shows that the test bench for geared systems (100) additionally comprises at least one belt tensioner (18), used in the assembly and tightening of the belts and pulleys (04).

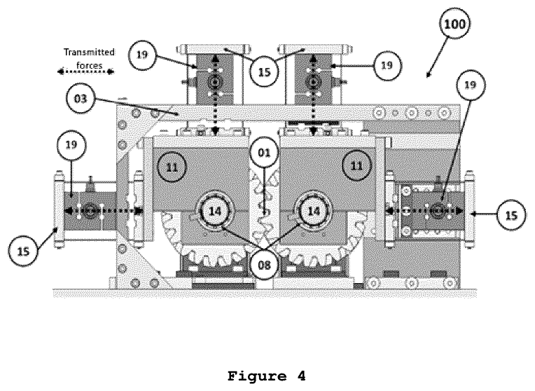

FIG. 4 shows details of the operation of the primary gear pair (01), wherein the force measurement assemblies (15) decouple the efforts resulting from the meshing into forces in the horizontal and vertical directions, transmitting the meshing efforts. Four (4) force measurement assemblies (15) and, respectively, four (4) load cells (19) are attached to the gantry (03). Two force measurement assemblies (15) are attached to the upper part of the bearing housings of the primary gear pair (11), and two force measurement assemblies (15) are attached to the outer side of the bearing housings of the primary gear pair (11).

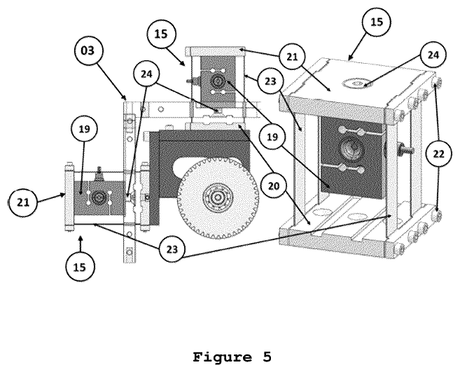

FIG. 5 shows a detailed view of the force measurement assemblies (15), wherein each of the assemblies comprises at least one load cell (19).

In particular, one end of the load cell (19) is rigidly fixed to the gantry (03) through fastening means (24), such as screws (24) or other fastening means known from the state of the art.

The other end of the load cell (19) is fixed through fastening means (24) to the upper base (21) of the force measurement assembly (15).

Furthermore, according to FIG. 5, the lower base (20) of the force measurement assembly (15) and the upper base (21) of the force measurement assembly (15) are connected by a plurality of rods, more preferably, by at least 4 (four) thin rods (23) with a thickness significantly less than their own width, wherein the rods (23) are fixed through rod fastening means (22). In this sense, the force measurement assembly (15) allows movement in the direction where the rods (23) have reduced thickness, and in other directions, the rods (23) behave rigidly.

The lower base (20) of the force measurement assembly (15) is attached to the bearing housings of the primary gear pair (11).

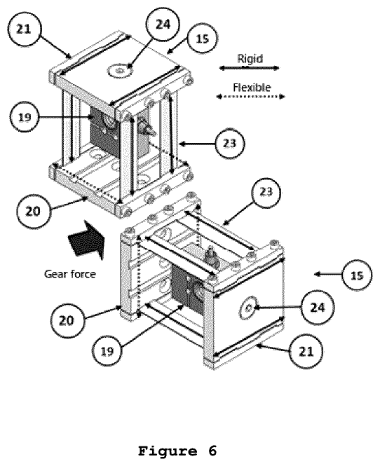

FIG. 6 illustrates the operating principle of the force measurement assembly (15), wherein it is possible to observe that the force measurement assembly (15) allows movement in the direction where the rods (23) have thinner thickness. FIG. 6 shows two force measurement assemblies (15) perpendicular to each other, that is, a force measurement assembly (15) vertically and a force measurement assembly (15) horizontally in relation to the primary gear pair (01).

Specifically, the rods (23) of the vertical force measurement assembly (15) are flexible in the direction of horizontal forces, where the horizontal forces are measured by the load cell (19) of the horizontal force measurement assembly (15). Similarly, the rods (23) of the horizontal force measurement assembly (15) are flexible in the vertical direction, with the vertical forces only being sensed by the load cell (19) of the vertical force measurement assembly (15). Thus, it is possible to decompose the forces resulting from the meshing into forces in the horizontal and vertical directions, which are measured by the load cells (19).

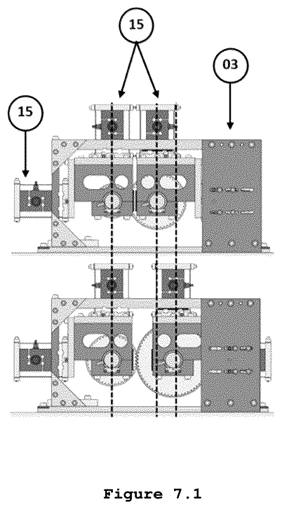

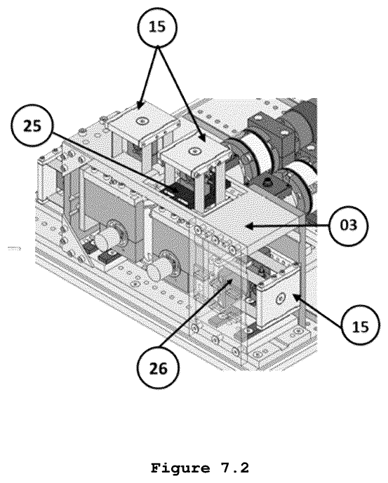

According to FIGS. 7.1 and 7.2, the force measurement assembly (15) allows for variation in the distance between the axles, in order to accommodate a wider range of gear diameters. More specifically, the gantry (03) includes at least one upper movable guide (25) and at least one lateral movable guide (26), where the force measurement assemblies (15) with the load cells (19) are attached, which are attached to the bearing housings of the primary gear pair (11).

FIGS. 7.1 and 7.2 illustrate two shafts attached to the force measurement assemblies (15). According to FIG. 7.1, the shaft and the force measurement assembly (15) located to the left of this figure do not move and are rigidly bolted to the gantry structure (03). The force measurement assembly (15) and the shaft on the right side of FIG. 7.1, however, can move, considering, for the force measurement assembly (15) in the vertical direction, the travel of the upper movable guide (25) of the gantry (03); and the lateral movable guide (26) of the gantry (03) to the force measurement assembly (15) horizontally. After adjusting the desired distance between the axes, the upper movable guide (25) and the lateral movable guide (26) are rigidly bolted to the gantry structure (03).

FIG. 7.2 illustrates that the upper movable guide (25) and the lateral movable guide (26) move relative to the gantry (03).

According to FIG. 7.1, it must be possible to translate the entire set of bench elements (100) to provide alignment with the right-hand gear, thus maintaining the alignment of the primary gear pair (01) and the secondary gear pair (02), at the correct center distance for the gear set to be evaluated.

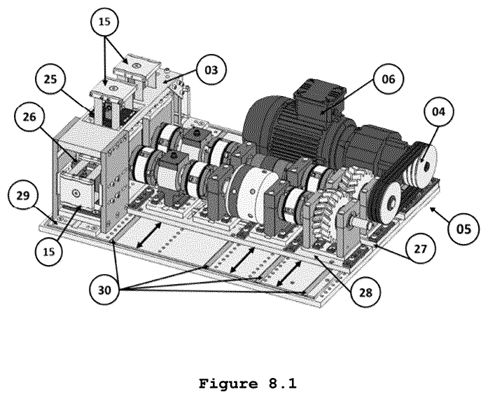

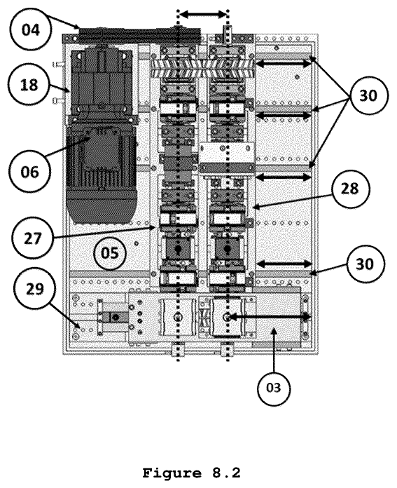

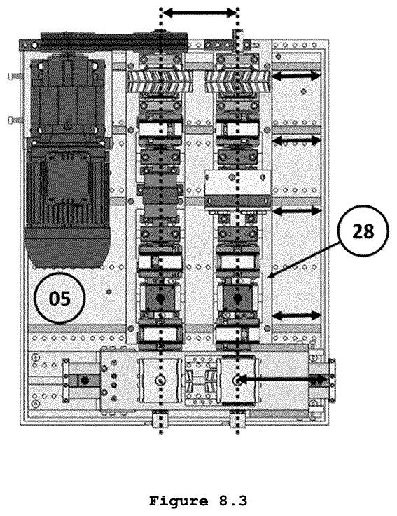

FIG. 8.1 illustrates a perspective view of the test bench for geared systems (100), highlighting the base (05) including a plurality of alignment recesses (30). Furthermore, the test bench for geared systems (100) further comprises at least one fixed plate (27) and at least one movable plate (28), which are coupled to the alignment recesses (30) through fastening means, such as guide pins. Furthermore, the test bench for geared systems (100) includes at least one gantry base plate (29).

FIGS. 8.2 and 8.3 illustrate the variation in the distance between the gear axes of the primary gear pair (01) and the secondary gear pair (02). The gantry (03) is fixed to the base (05) by means of the gantry base plate (29), which allows an initial adjustment of the position of the gantry (03) in relation to the driving system (06), considering that it must be possible to assemble and tension the set of belts and pulleys (04) by means of the belt tensioner (18) that moves the driving system (06). Thus, after the initial alignment between the gantry (03) by means of the gantry base plate (29) in relation to the driving system (06), the distance between the axles referring to the gears evaluated is adjusted by the movement of the upper mobile guide (25) and the lateral mobile guide (26), located in the gantry (03), as well as by the movement of the mobile plate (28) that moves on the base (05). Once the position of the gantry base plate (29) and, consequently, the gantry (03) has been defined, these are rigidly bolted and do not move in relation to the base (05). With this, the set of components of the left shaft, as shown in FIG. 7.1, is mounted on the fixed plate (27), which ensures alignment between the primary gear pair (01) and the secondary gear pair (02).

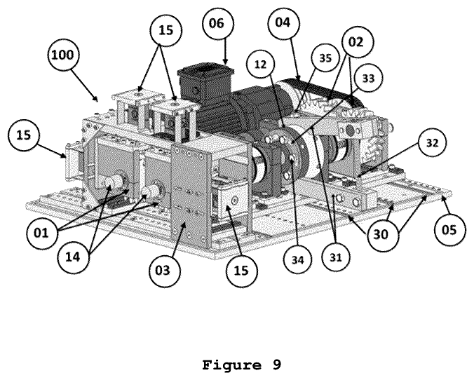

FIG. 9 illustrates the test bench for geared system (100) and, in more detail, the torque applicator (12), which includes at least 2 (two) flanges, which can be angularly offset by means of arms with nuts (31) and adjustment means (32), wherein the arms with nuts (31) are articulated and attached to the flanges through means for fixing the arm to the flange (35). The adjustment means (32) can be at least one screw (32). Thus, tightening the adjustment screw (32) in the arms with nuts (31) generates an offset between the flanges that make up the torque applicator (12), eliminating the existing clearances due to the fact that the bench (100) comprises the configuration of a closed power circuit between the primary gear pair (01) and the secondary gear pair (02), ending up generating a load due to the torsion applied to the torque applicator (12). This is possible due to the oblongs (33) in which the screws (34) are threaded.

More specifically, according to FIG. 9, the applied load is calibrated using torque wrenches (17). Once the load is applied, the screws (34) are tightened, preventing relative movement in the oblongs (33). Once locked, the arms with nuts (31), the adjustment screw (32), and the means for attaching the arm to the flange (35) are removed for testing and experiments.

Furthermore, according to FIG. 10, the test bench for geared system (100) additionally comprises a plurality of sensors (36, 37) mounted on the gantry (03), wherein the plurality of sensors comprises at least one of:
at least one accelerometer (36) mounted on the side and top of the at least one bearing pair of the primary gear pair (11);
at least one thermocouple sensor (37) arranged within at least one first lubricating oil box (38) of the primary gear pair (01);
wherein the at least one first lubricating oil box (38) includes at least a first lubricating oil box cover (39) and a first lubricating oil box support base (40); wherein the first lubricating oil box support base (40) is arranged between the first lubricating oil box (38) and the gantry base plate (29);
or any other sensor.

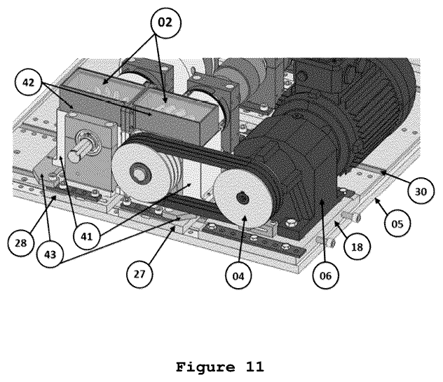

Furthermore, according to FIG. 11, the secondary gear pair (02) includes at least one second lubricating oil box (41) and at least one cover of the second lubricating oil box (42); wherein the cover of the second lubricating oil box (42) may have an upper region of transparent acrylic. The second lubricating oil box (41) is attached to the fixed plate (27) and the movable plate (28) through box fixing means (43).

Specifically, the first lubricating oil box (38) and the second lubricating oil box (41) may have adequate internal space for modifying small displacements between shafts without the need for replacement by boxes of different dimensions.

Thus, those skilled in the art will appreciate the knowledge being indicated and will be able to reproduce the present invention described in the preferred embodiment, covered by the scope of the appended claims.

### RESULTS AND EXAMPLE OF APPLICATION OF THE INVENTION

An example of the application of the test bench for geared systems of the present invention is carried out from the need to evaluate spur gears with diameters between 80 mm and 230 mm and thicknesses of up to 50 mm, as exemplified in FIG. 11.

The test bench for geared systems of the present invention also supports tests on helical gears, as long as they are assembled in pairs with opposing helicoids (herringbone shape), in order to cancel the lateral forces on the support bearings.

The drive system supports tests with rotations of up to 500 rpm, and this value can be adjusted by replacing the transmission system that connects the electric motor to the bench, in order to increase or reduce the maximum torque and rotation for tests or experiments.

The applied torque range can be varied up to 300 Nm in both directions. This can be achieved by replacing the flexible couplings connecting the components, which can be sized for a maximum load of 300 Nm in an exemplary configuration, so as not to add excessive rigidity to the experiments.

Furthermore, a test bench for geared systems is flexible for conducting experiments with several types of gears, which must be centered in relation to the load cells that measure the forces to ensure accuracy.

In the case of spur gears, they must be mounted centered, and for helical gears, they must be mounted in a herringbone configuration to neutralize lateral loads arising from the helix angle of the teeth.

Specifically, the test bench for geared systems of the present invention aims to extract data regarding the kinematic and dynamic behavior of geared systems for modeling these systems. Accurate modeling of geared systems requires a series of parameters that are difficult to obtain and are not available in the literature. Furthermore, precisely defining the line of action of the gear is practically impossible through mathematical models, since this aspect depends on several factors, such as the flexure of the teeth during contact, which varies with the applied load, as well as defects and imperfections in the geometry of the teeth during contact.

Therefore, the test bench for geared systems of the present invention allows the evaluation of a series of parameters related to geared systems, including effects resulting from the insertion of known and controlled defects in the components.

Specifically, the test bench for geared systems of the present invention comprises a closed power circuit that uses two pairs of similar gears. This arrangement allows for the decoupling of the torque and rotation regimes of the bench, since the load (torque) is applied by a torque application system, which allows for the controlled angular displacement of two flanges, generating a torsion in the system that represents the continuously applied load, without generating system acceleration, as would occur in a conventional geared reducer with power input and output. Finally, the rotation is controlled by an electric motorization system, thus enabling the analysis of several torque and rotation conditions of the system, allowing for a broad mapping of the operating conditions of a geared pair under analysis.

The gantry crane can be called an instrumented gantry crane because it is equipped with several sensors, such as load cells, torque meters, encoders, thermocouples, and accelerometers. These sensors are used to measure several kinematic and dynamic effects during experiments. The data obtained from these measurements can be used to determine parameters used in equations or numerical models.

The closed power loop is a closed system where there is no load present, but there are torque losses due to the efficiency of the components. To simulate operation under different load conditions, a torque applicator system is introduced into the closed loop between the primary and secondary gear pairs. This torque applicator allows the application of known loads to the system, which can be calibrated using torque meters attached to the shafts connecting the primary and secondary gear pairs.

Furthermore, the electric drive system or motorization system allows for precise rotation control. This rotation is monitored on both shafts using encoders. Furthermore, the temperature of the lubricating fluid can also be monitored using thermocouples, providing a wide range of information about the operating conditions.

During operation, after applying a fixed load to the torque applicator, it is possible to measure the vertical and lateral forces in the primary gear pair. Torque meters in the circuit provide information on the applied torque, including preload and the dynamic effects of the meshing. The speed variation during the meshing process is also monitored by the encoders, and the frequencies acting during the experiment are measured by accelerometers installed in the primary gear pair bearing housings.

Furthermore, it is possible to adjust the distance between the shafts of the closed loop, which allows measurements to be made on multiple gear pairs, whether spur or helical. The test bench for geared system offers the opportunity to collect a large amount of data, containing several essential parameters for improvements and adjustments in mathematical models of geared systems. Furthermore, the test bench for geared system allows for the study of variations in results due to defects, both manufacturing and wear.

The main applications of the test bench for geared system of the present invention are in the modeling of geared systems, considering highly complex models, which allow for the anticipation of failures in machine designs, in which critical parts of the design can be validated in advance.

Another application of the test bench for geared system of the present invention is to simulate sets of functional designs, which present analogous characteristics for which predictive investigation in real equipment is not feasible.

Furthermore, in the test bench for geared system of the present invention, it is possible to insert gears with known faults, such as surface wear or measurable cracks, to characterize the differences caused by these defects in the kinematics and dynamics of the system, making it possible to calibrate the mathematical models to predict potential faults in the system.

What is claimed is:

1. A test bench for geared systems, comprising:
at least one primary gear pair;
at least one secondary gear pair,
at least one gantry;
at least one belt and pulley assembly;
wherein the primary gear pair is mounted on the gantry;
wherein the secondary gear pair is connected to the belt and pulley assembly; and
wherein the secondary gear pair is positioned on the opposite side of the primary gear pair;
at least one base;
wherein the base includes at least one alignment recess;
at least one drive system;
wherein the secondary gear pair is connected to the drive system through the belt and pulley assembly;
at least one torque application system;
a plurality of force measurement assemblies;
at least one torque meter mounted on each gear of the primary gear pair,
a plurality of sensors mounted on the gantry.

2. A test bench for geared systems, according to claim 1, wherein the at least one drive system is at least one electric drive motor.

3. A test bench for geared systems, according to claim 1, wherein the bench additionally comprises:
a plurality of bearings;
a first double-bearing bearing pair that supports the at least one torque application system;
at least one second double-bearing bearing pair supporting at least one flexible coupling;
wherein the at least one flexible coupling is mounted on the shaft opposite the torque application system;
at least one second single-bearing bearing;
wherein the at least one secondary gear pair is supported on the at least one second single-bearing bearing;
at least one bearing pair of the primary gear pair fixed to the gantry;
wherein the at least one primary gear pair is arranged on the at least one bearing pair of the primary gear pair.

4. A test bench for geared systems, according to claim 1, wherein each of the plurality of force measurement assemblies includes at least one load cell;
wherein each of the plurality of force measurement assemblies includes an upper base and a lower base;
wherein one end of the load cell is attached to the gantry by means of fastening means;
wherein another end of the load cell is attached by means of fastening means to the upper base of the force measurement assembly;
wherein the upper base and the lower base are connected by a plurality of rods by means of rod fastening means;
wherein the plurality of rods has a thickness less than their width.

5. A test bench for geared systems, according to claim 1, wherein the bench additionally comprises:
at least one encoder arranged at the ends of the shafts of the primary gear pair;
at least one blade coupling;
at least one belt tensioner.

6. A test bench for geared systems, according to claim 1, wherein the plurality of force measurement assemblies comprises four force measurement assemblies, wherein two force measurement assemblies are attached to the upper part of the bearing housings of the primary gear pair, through the lower base of the force measurement assembly; and two force measurement assemblies are attached to the outer side of the bearing housings of the primary gear pair.

7. A test bench for geared systems according to claim 4, wherein the lower base of the force measurement assembly is fixed to the bearing housings of the primary gear pair.

8. A test bench for geared systems, according to claim 1, wherein the gantry includes at least one upper movable guide and at least one lateral movable guide, where the force measurement assemblies are fixed; and
wherein the at least one upper movable guide and the at least one lateral movable guide move relative to the gantry.

9. A test bench for geared systems, according to claim 1, wherein the at least one base includes a plurality of alignment recesses, at least one fixed plate and at least one movable plate;
wherein the at least one fixed plate and the at least one movable plate are coupled to the alignment recesses by means of fastening means;
wherein the movable plate is movable on the base;
wherein the at least one base also includes at least one gantry base plate; and
wherein the gantry is fixed to the base by means of the gantry base plate.

10. A test bench for geared systems, according to claim 1, wherein the torque applicator includes at least two flanges;
wherein the flanges are angularly offset by arms with nuts and adjustment means; and
wherein the arms with nuts are articulated and secured to the flanges through means for attaching the arm to the flange.

11. A test bench for geared systems, according to claim 1, wherein the plurality of sensors comprises at least one of:
at least one accelerometer and at least one thermocouple sensor;
wherein the at least one accelerometer is mounted on the side and top of at least one bearing pair of the primary gear pair;
wherein the at least one thermocouple sensor is arranged within at least one first lubricating oil box of the at least one primary gear pair;
wherein the at least one first lubricating oil box includes at least one first lubricating oil box cover and a first lubricating oil box support base;
wherein the first lubricating oil box support base is arranged between the first lubricating oil box and at least one gantry base plate;
wherein the at least one secondary gear pair includes at least one second lubricating oil box and at least one second lubricating oil box cover;
wherein the at least one second lubricating oil box is attached to at least one fixed plate and at least one movable plate by means of housing fixing means.
